(19) United States
(12) Patent Application Publication
(10) Pub. No.: US 2025/0298821 A1
(43) Pub. Date: Sep. 25, 2025

(54) REDUCING HALLUCINATIONS FOR GENERATIVE TEXT RESPONSES USING A MACHINE LEARNING PROMPT ENSEMBLE

(71) Applicant: Adobe Inc., San Jose, CA (US)

(72) Inventors: Tong Yu, San Jose, CA (US); Xiang Chen, Palo Alto, CA (US); Victor Soares Bursztyn, Mountain View, CA (US); Sungchul Kim, San Jose, CA (US); Ryan A Rossi, Santa Clara, CA (US); Ruiyi Zhang, San Jose, CA (US); Rui Wang, Durham, NC (US)

(21) Appl. No.: 18/612,566

(22) Filed: Mar. 21, 2024

(51) Int. Cl. G06F 16/33; G06F 16/383

(52) U.S. Cl. CPC G06F 16/3344; G06F 16/383

(57) ABSTRACT

The present disclosure relates to systems, methods, and non-transitory computer-readable media that iteratively generates, utilizing a machine learning model, text responses to reduce hallucinated content. In particular, in some embodiments, the disclosed systems receive a digital query and selects one or more supporting digital documents for the digital query. Furthermore, in some embodiments the disclosed systems generate a first text response from a first text prompt generated by using the digital query. Moreover, in some embodiments the disclosed systems extract a misalignment portion of the first text response by comparing the first text response and the one or more supporting digital documents. Additionally, from the misalignment portion of the first text response and the digital query, the disclosed systems further generate a second text response.

### BACKGROUND

Recent years have seen significant improvements in hardware and software platforms for generating responses to queries using large language models. To illustrate, conventional systems have demonstrated significant improvements in tasks such as language translation, text generation, sentiment analysis, question answering, and other natural language tasks. Although conventional systems have experienced significant strides in text generation and other natural language tasks, such systems suffer from a number of technical deficiencies including inaccuracy and operational inflexibility of implementing computing devices.

As just mentioned, in one or more implementations, conventional systems suffer from computational inaccuracies. For example, conventional systems frequently receive a digital query and generate a response not grounded by pertinent documents related to the query. Such a phenomenon is called hallucination and conventional systems commonly experience hallucinations in text generation tasks. Moreover, because conventional systems suffer from hallucinations in generating text responses, conventional systems typically generate and transmit inaccurate responses.

Relatedly, in one or more implementations, conventional systems suffer from operational inflexibility. For example, conventional systems can generate text responses to digital queries but often utilize rigid approaches, such as pre-defined machine learning inputs. Such an approach limits conventional systems to information contained in training data and rigid, pre-defined inputs. Accordingly, conventional systems cannot flexibly adapt or consider other dynamic, external resources in generating outputs for language machine learning tasks.

### SUMMARY

This disclosure describes one or more embodiments that provide benefits and/or solve some or all of the foregoing problems with systems and methods that reduce response hallucination of language machine learning models by sequentially generating prompts, identifying hallucinated content, and using the hallucinated content as negative examples for subsequent prompts. For example, in one or more embodiments, the disclosed systems receive a digital query and selects one or more supporting digital documents for the digital query. In particular, the disclosed systems generate a text response using a text prompt generated from the digital query and extracts a misalignment portion of the text response. For instance, the disclosed systems compare the text response with the one or more supporting digital documents to extract a misalignment portion. Moreover, the disclosed systems generate an additional text response by using the digital query and the misalignment portion (e.g., the misalignment portion as a negative example). To illustrate, the disclosed systems generate a plurality of text responses for a digital query and selects a text response with the least amount of hallucination (e.g., misalignment portions).

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a machine learning prompt ensemble system operates in accordance with one or more embodiments;

FIGS. 2A-2B illustrates an overview of the machine learning prompt ensemble system extracting a misalignment portion from a text response and further generating an additional text response in accordance with one or more embodiments;

FIG. 3 illustrates a diagram of the machine learning prompt ensemble system generating a plurality of text responses and identifying a text response with the highest relative alignment score in accordance with one or more embodiments;

FIG. 4 illustrates a diagram of the machine learning prompt ensemble system comparing sentences of a text response to one or more supporting digital documents in accordance with one or more embodiments;

FIG. 5 illustrates a diagram of the machine learning prompt ensemble system comparing the alignment scores to an alignment threshold to generate a negative example set in accordance with one or more embodiments;

FIGS. 6A-6D illustrates example graphical user interfaces of a client device including a digital query along with additional elements in accordance with one or more embodiments;

FIG. 7 illustrates a table that compares generate text responses of the machine learning prompt ensemble system with prior systems in accordance with one or more embodiments;

FIG. 8 illustrates a schematic diagram of the machine learning prompt ensemble system in accordance with one or more embodiments;

FIG. 9 illustrates a flowchart of a series of acts for generating an additional text prompt from a digital query and a misalignment portion in accordance with one or more embodiments;

FIG. 10 illustrates a flowchart of a series of acts for generating a negative example set in accordance with one or more embodiments;

FIG. 11 illustrates a block diagram of an exemplary computing device in accordance with one or more embodiments.

### DETAILED DESCRIPTION

This disclosure describes one or more embodiments of a machine learning prompt ensemble system that reduces hallucinations for generative text responses using a machine learning prompt ensemble. In particular, the machine learning prompt ensemble system utilizes a framework that constructs text prompts and selects from the constructed text prompts to reduce or eliminate response hallucination. For example, in some embodiments, the machine learning prompt ensemble system operates in various environments such as an intelligent assistant application, a search engine, or other environments that includes text generation capabilities (e.g., a query and answer setup). For instance, the machine learning prompt ensemble system receives a digital query and identifies supporting digital documents that correspond to the digital query. Further, in some embodiments, the machine learning prompt ensemble system iteratively generates text responses to the digital query. Moreover, in some embodiments, the machine learning prompt ensemble system iteratively improves each subsequent response by using misalignment portions from a prior response as a negative example.

As mentioned, in one or more implementations the machine learning prompt ensemble system performs an iterative process of generating text responses to a digital query. Specifically, in one or more embodiments, the machine learning prompt ensemble system selects one or more supporting documents (e.g., utilizing an embedding comparison approach) corresponding to the digital query. Moreover, in some implementations, the machine learning prompt ensemble system utilizes the supporting documents to identify hallucinated content in responses generated from previous text prompts. For example, the machine learning prompt ensemble system compares responses to supporting documents, identifies hallucinated content (e.g., the misalignment portions), and then utilizes the hallucinated content as hard negative examples to avoid in subsequent iterations. For instance, the machine learning prompt ensemble system includes (in newly generated prompts) instructions for a language machine learning model to avoid generating the hallucinated content, as indicated by the negative examples.

In some embodiments, the machine learning prompt ensemble system identifies the misalignment portions (e.g., the negative examples) by using an alignment score model. Specifically, the machine learning prompt ensemble system uses the alignment score model to score a response on a sentence-by-sentence level and compares each sentence of the response with each of the identified supporting digital documents. In some instances, the machine learning prompt ensemble system selects a sentence with the lowest alignment score and inserts the sentence with the lowest alignment score into the negative example set.

In some embodiments, the machine learning prompt ensemble system employs this iterative strategy such that each subsequent response includes content that avoids the hallucinated content from the previous prompt. In doing so, the machine learning prompt ensemble system reduces hallucination which in turn improves the quality and accuracy of generative responses.

Moreover, in some embodiments, the machine learning prompt ensemble system selects a response from a plurality of generated responses. Specifically, the machine learning prompt ensemble system measures the quality of a response in terms of a degree to which the response is grounded by the supporting digital documents. For example, the machine learning prompt ensemble system uses the alignment score model to select a response that is least likely to include hallucinated content.

As mentioned above, conventional systems suffer from a variety of issues in relation to inaccuracy, and operational inflexibility. The machine learning prompt ensemble system provides a variety of technical benefits relative to such conventional systems. For example, in one or more embodiments, the machine learning prompt ensemble system improves accuracy of implementing computing devices. For instance, the machine learning prompt ensemble system reduces hallucinated content in generated responses by using an iterative process that involves generating a text response, extracting a misalignment portion from the text response, and using the misalignment portion in a new text prompt to generate an additional response. Specifically, in some instances, the machine learning prompt ensemble system reduces hallucinations by identifying misalignment portions of previous responses and designating the misalignment portion as a hard negative example. Moreover, the machine learning prompt ensemble system generates a plurality of text responses and selects a text response with the least amount of hallucinated content. Thus, in one or more implementations, the machine learning prompt ensemble system improves upon accuracy of generated responses for digital queries.

In addition to improving upon accuracy, in some embodiments, the machine learning prompt ensemble system improves upon operational flexibility. For example, in one or more implementations, the machine learning prompt ensemble system robustly generates responses that are responsive to the digital query and grounded in supporting digital documents. Specifically, the machine learning prompt ensemble system uses the framework of iterative response generation and extraction of misalignment portions to flexibly adapt responses based on dynamic, external resources such as a repository of supporting digital documents. Thus, the machine learning prompt ensemble system is not limited to generating responses from a rigid corpus of training documents but can adjust responses to avoid hallucination as indicated by an additional repository that includes supporting documents relevant to a particular query.

As mentioned, conventional systems fail to accurately ground responses to digital queries in the supporting digital documents. Such conventional systems, however, are often inefficient in providing resources to retrieve and evaluate source documents. For example, conventional systems utilize training documents to train machine learning models but are often unable to identify what specific documents are pertinent to any particular result. Thus, client devices often spend significant resources searching for and identifying documents that support responses generated from conventional models. In contrast, the machine learning prompt ensemble system reduces time, interfaces, interactions, and computing resources by identifying and providing supporting digital documents for a response generated by a language machine learning model. For instance, the machine learning prompt ensemble system provides a graphical user interface that includes options to show the supporting digital documents along with the response and the level of alignment of the response relative to the supporting digital documents.

As demonstrated from the discussion above, the current application uses a variety of terms and phrases to describe the machine learning prompt ensemble system. In one or more embodiments, “a digital query” refers to a computer-generated request for a response (e.g., a verbal, audio, or text request from a client device for a verbal, audio, or text response corresponding to the query). To illustrate, a digital query can include text entered via a user interface that comprises a question related to a particular topic. A digital query can comprise a request for a variety of information including a summary or explanation corresponding to a topic, information regarding how to use a particular application or application feature, information from a particular database, etc. Additionally, in some embodiments, the digital query contains a first order query, while in some embodiments the digital query contains a multi-order query. In other words, in some embodiments, the digital query indicates a single task, while in some embodiments, the digital query indicates multiple tasks (e.g., how to generate x with y and also how to generate z from x).

Further, as also mentioned, the machine learning prompt ensemble system identifies supporting digital documents for a digital query. In one or more embodiments, “supporting digital documents” refers to one or more digital documents that relate or correspond to a digital query. For example, supporting digital documents includes documents that a computer-implemented model identifies as relevant or related to a digital query.

In some implementations, the supporting digital documents include documents that were not used to train a language machine learning model. For instance, the machine learning prompt ensemble system trains a language machine learning model on a training corpus (e.g., in some instances the training corpus includes some of the supporting digital documents). After training, in some embodiments, the machine learning prompt ensemble system accesses and analyzes supporting digital documents along with the digital query to generate a response. In other words, in some embodiments, the supporting digital documents augment the training corpus for the language machine learning model to generate a response. For instance, the machine learning prompt ensemble system utilizes the language machine learning model to reference the supporting digital documents when generating a response.

In some instances, the machine learning prompt ensemble system obtains the supporting digital documents from a repository of digital documents. In one or more embodiments, the repository of digital documents stores supporting digital documents. Specifically, the repository of digital documents stores a plurality of digital documents, and the machine learning prompt ensemble system identifies one or more digital documents from the repository of digital documents to utilize with the digital query. For example, the repository of digital documents includes a database that stores, organizes, and/or retrieves digital documents. For instance, for different environments that the machine learning prompt ensemble system operates in, the machine learning prompt ensemble system establishes a repository of digital documents that includes relevant digital documents containing information related to the operating environment.

In some embodiments, the machine learning prompt ensemble system utilizes machine learning to reduce hallucinations in responses. In one or more embodiments a “machine learning model” includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a “neural network” includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

As mentioned previously, the machine learning prompt ensemble system provides the digital query to a language machine learning model. For example, a language machine learning model includes artificial intelligence models capable of processing and generating natural language text. In particular, language machine learning models are trained on large amounts of data to learn patterns and rules of language. Accordingly, the term “language machine learning model” includes or refers to one or more neural networks capable of processing natural language text to generate outputs that range from predictive outputs, analyses, or combinations of data within stored content items (e.g., large language models and language transformer models). In particular, a language machine learning model includes parameters trained (e.g., via deep learning) on large amounts of data to learn patterns and rules of language for summarizing and/or generating digital content. Examples of language machine learning models include BLOOM, Bard Al, ChatGPT (e.g., GPT-3.5, GPT-4, etc.), LaMDA, DialoGPT.

As mentioned, the machine learning prompt ensemble system utilizes the language machine learning model to generate a text response to a digital query. In one or more embodiments, “a text response” refers to an output from the language machine learning model that is responsive to a digital query. For example, the text response includes a response with information, explanations, or suggestions, or examples that illustrate an answer to the digital query.

As mentioned above, the machine learning prompt ensemble system utilizes a text prompt that includes the digital query and a misalignment portion. In one or more embodiments, “a text prompt” refers to a text signal or input for a language machine learning model. Specifically, a text prompt refers to text that is provided to a machine learning model to generate a response. For example, if a digital query includes “explain to me how to create a blog post” the machine learning prompt ensemble system identifies supporting digital documents and generates a text prompt from the digital query with further instructions to reference the identified supporting digital documents. In other words, the machine learning prompt ensemble system transforms the digital query to generate a text prompt that includes specific instructions for how to generate a response for the digital query.

As also mentioned, the machine learning prompt ensemble system utilizes an alignment score model to identify the misalignment portions. In one or more embodiments, “an alignment score model” refers to a computer-implemented model for evaluating the alignment, relevance, or correspondence between two digital content items (e.g., alignment between a response and one or more digital documents). Specifically, the machine learning prompt ensemble system utilizes the alignment score model to generate a similarity or alignment score between a response and supporting digital documents. For example, the alignment score model allows the machine learning prompt ensemble system to evaluate when certain responses contain hallucinatory content (e.g., content that is not supported by the supporting digital documents). For instance, the machine learning prompt ensemble system utilizes the alignment score model to generate a semantic similarity score (e.g., the alignment of the meaning of the response with the supporting digital documents) and/or a contextual relevance score (e.g., the alignment of the response with the context of the supporting digital documents).

As is mentioned above, the machine learning prompt ensemble system reduces hallucinated content (e.g., misalignment portions). In one or more embodiments, “a misalignment portion” of a text response refers to all or part a response that fail to align with one or more supporting digital documents. For instance, a misalignment portion includes one or more parts of a response that fail to satisfy a threshold alignment or similarity measure relative to one or more supporting documents. For example, the machine learning prompt ensemble system establishes a threshold alignment score and if an alignment score fails to satisfy that threshold, then the machine learning prompt ensemble system determines that the portion of the response is a misalignment portion.

As also mentioned above, in some embodiments, the machine learning prompt ensemble system utilizes the misalignment portions as a negative example set. In one or more embodiments, “a negative example set” refers to one or more example sentences or one or more responses that the machine learning prompt ensemble system utilizes as a negative example. In other words, the machine learning prompt ensemble system generates a text response by referencing the negative example set and steers away from generating a text response that reflects any of the sentences or text responses in the negative example set. Specifically, the negative example set includes sentences or text response identified with misalignment portions (e.g., sentences or responses that fail to satisfy an alignment threshold). For example, the machine learning prompt ensemble system generates a text prompt with the negative example set and instructions in the prompt to not generate a response with content from the negative example set.

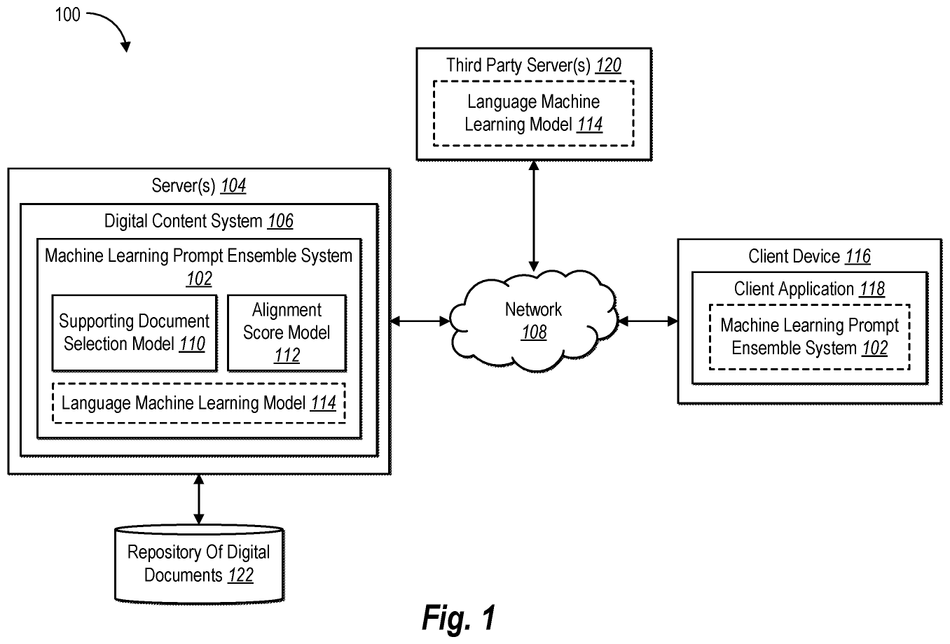

Additional details regarding the machine learning prompt ensemble system will now be provided with reference to the figures. For example, FIG. 1 illustrates a schematic diagram of an exemplary system environment 100 in which a machine learning prompt ensemble system 102 operates. As illustrated in FIG. 1, the system environment 100 includes a server(s) 104, a digital content system 106, a supporting document selection model 110, an alignment score model 112, a language machine learning model 114, a repository of digital documents 122, a network 108, a third-party server(s) 120, a client device 116, and a client application 118.

Although the system environment 100 of FIG. 1 is depicted as having a particular number of components, the system environment 100 is capable of having a different number of additional or alternative components (e.g., a different number of servers, client devices, or other components in communication with the machine learning prompt ensemble system 102 via the network 108). Similarly, although FIG. 1 illustrates a particular arrangement of the server(s) 104, the network 108, and the client device 116, various additional arrangements are possible.

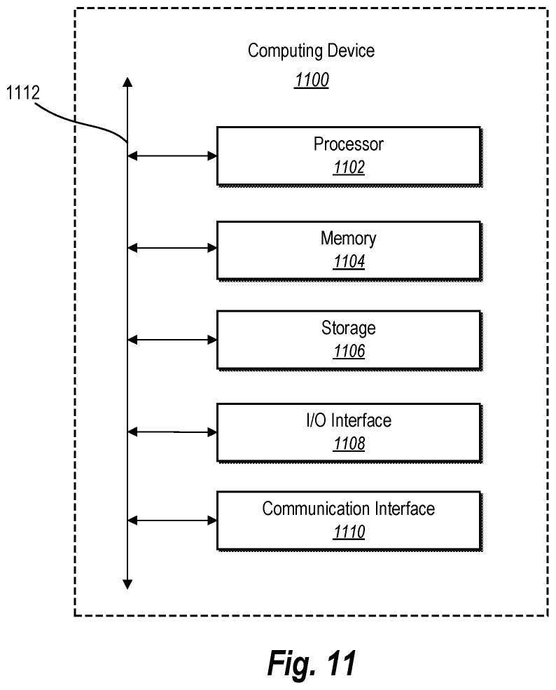

The server(s) 104, the network 108, the client device 116, and the third-party server(s) 120 are communicatively coupled with each other either directly or indirectly (e.g., through the network 108 discussed in greater detail below in relation to FIG. 11). Moreover, the server(s) 104 and the client device 116 include one or more of a variety of computing devices (including one or more computing devices as discussed in greater detail in relation to FIG. 11).

As mentioned above, the system environment 100 includes the server(s) 104. In one or more embodiments, the server(s) 104 via the machine learning prompt ensemble system 102 trains a language model to create the language machine learning model 114. In one or more embodiments, the server(s) 104 processes a digital query to generate a text response to provide to a user of the client application 118. In one or more embodiments, the machine learning prompt ensemble system 102 houses the supporting document selection model 110 to select one or more supporting digital documents for a digital query and the alignment score model 112 to score one or more portions of a text response.

Further, in one or more embodiments, the system environment 100 includes the third-party server(s) 120 which separately house the language machine learning model 114. For instance, the language machine learning model 114 is trained to process text prompts and output text responses to the prompts. Accordingly, in some instances, the machine learning prompt ensemble system 102 sends the text prompt to the third-party server(s) 120 to utilize the language machine learning model 114.

In one or more embodiments, the client device 116 includes a computing device that is able to provide for display, elements within a graphical user interface such as interface panels for configuring a query and the number of iterations (e.g., to generate a number of responses) via the client application 118. For example, the client device 116 includes smartphones, tablets, desktop computers, laptop computers, head-mounted-display devices, or other electronic devices. The client device 116 includes one or more applications (e.g., a digital analytics application, digital content application, or any application with query-answer setup) for sending instructions to create one or more responses in accordance with the digital content system 106. For example, in one or more embodiments, the client application 118 works in tandem with the machine learning prompt ensemble system 102 to receive a digital query and generate one or more responses to the digital query while extracting the misalignment portion(s) from the responses. In particular, the client application 118 includes a software application installed on the client device 116. Additionally, or alternatively, the client application 118 of the client device 116 includes a software application hosted on the server(s) 104 which may be accessed by the client device 116 through another application, such as a web browser.

In one or more embodiments, the machine learning prompt ensemble system 102 receives a digital query from the client device 116 and generates a text response via the language machine learning model 114. Further, in some embodiments, the machine learning prompt ensemble system 102 utilizes the supporting document selection model which is in communication with the repository of digital documents 122, to generate the text response. In some embodiments, from the text response, the machine learning prompt ensemble system 102 utilizes the alignment score model 112 to extract a misalignment portion from the text response or to select a text response from multiple text responses based on an alignment score (e.g., to provide the selected text response to the client device 116).

To provide an example implementation, in some embodiments, the machine learning prompt ensemble system 102 on the server(s) 104 supports the machine learning prompt ensemble system 102 on the client device 116. For instance, in some cases, the digital content system 106 on the server(s) 104 gathers data for the machine learning prompt ensemble system 102. In response, the machine learning prompt ensemble system 102, via the server(s) 104, provides the information to the client device 116. In other words, the client device 116 obtains (e.g., downloads) the machine learning prompt ensemble system 102, the language machine learning model 114, the supporting document selection model 110, and the alignment score model 112 from the server(s) 104. Once downloaded, the machine learning prompt ensemble system on the client device 116 provides one or more text responses based on one or more digital queries.

In alternative implementations, the machine learning prompt ensemble system 102 includes a web hosting application that allows the client device 116 to interact with content and services hosted on the server(s) 104. To illustrate, in one or more implementations, the client device 116 accesses a software application supported by the server(s) 104. In response, the machine learning prompt ensemble system 102 on the server(s) 104, utilizes the language machine learning model 114, the supporting document selection model 110, and the alignment score model 112. The server(s) 104 provides the text responses to the client device 116 for display.

To illustrate, in some cases, the machine learning prompt ensemble system 102 on the client device 116 receives a digital query. The client device 116 transmits the digital query to the server(s) 104. In response, the machine learning prompt ensemble system 102 on the server(s) 104 determines to generate a number of iterations for the digital query and causes the client device 116 to display, in some embodiments, one or more generated responses, alignment scores, and/or supporting digital documents via the graphical user interface of the client application 118.

In alternative implementations, the system environment 100 includes multiple client devices (e.g., in addition to the client device 116), and additional repository of digital documents corresponding to the multiple client devices. In some instances, a client device can have access to one or more repositories of digital documents (e.g., digital documents related to different environments).

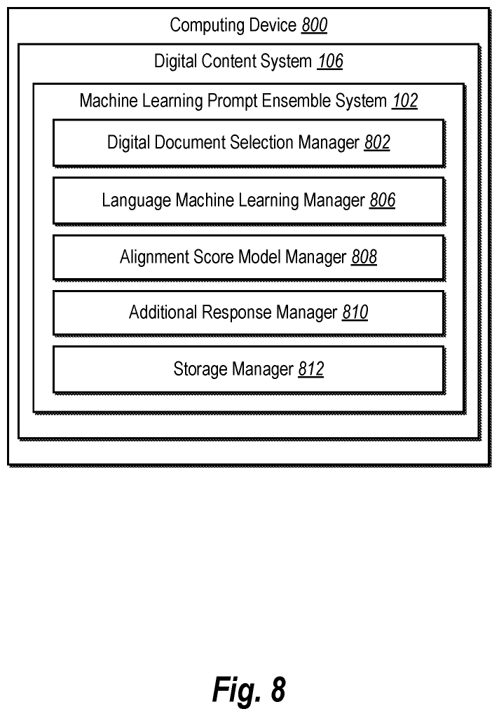

Indeed, in some embodiments, the machine learning prompt ensemble system 102 is implemented in whole, or in part, by the individual elements of the system environment 100. For instance, although FIG. 1 illustrates the machine learning prompt ensemble system 102 implemented or hosted on the server(s) 104, different components of the machine learning prompt ensemble system 102 are able to be implemented by a variety of devices within the system environment 100. For example, one or more (or all) components of the machine learning prompt ensemble system 102 are implemented by a different computing device (e.g., the client device 116) or a separate server from the server(s) 104. Indeed, as shown in FIG. 1, the client device 116 includes the machine learning prompt ensemble system 102. Example components of the machine learning prompt ensemble system 102 will be described below with regard to FIG. 8.

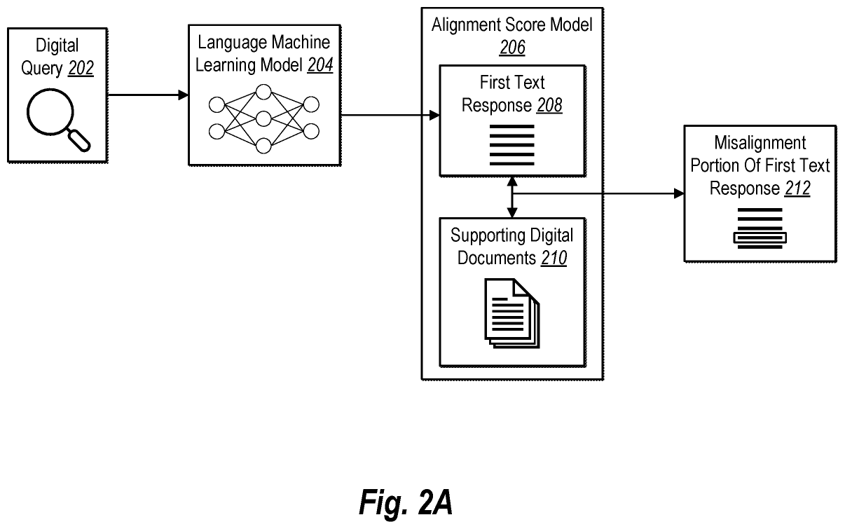

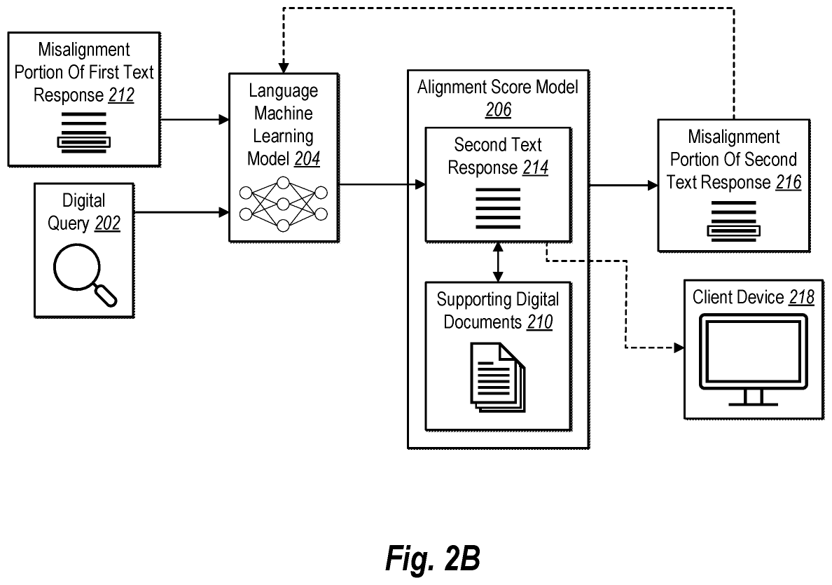

As mentioned above, in certain embodiments, the machine learning prompt ensemble system 102 extracts a misalignment portion from a text response. FIG. 2A illustrates an overview of the machine learning prompt ensemble system 102 generating a text response for a digital query and extracting a misalignment portion in accordance with one or more embodiments. For example, FIG. 2A shows the machine learning prompt ensemble system 102 receiving a digital query 202 and using a language machine learning model 204 to process the digital query 202.

In one or more embodiments, the machine learning prompt ensemble system 102 receives the digital query 202 and selects a template prompt. In particular, the machine learning prompt ensemble system 102 selects a template prompt and populates one or more fields of template prompt based on the digital query 202. Specifically, the machine learning prompt ensemble system 102 sends the template prompt (that includes the digital query 202) to the language machine learning model 204 to generate a text response. For example, “a template prompt” refers to a structured and predefined text input to guide the generation of a text response. Specifically, the template prompt includes description texts and description fields. For example, a description text of the template prompt describes to the machine learning prompt ensemble system 102 how to use a description field. Further, the description field includes a placeholder for the machine learning prompt ensemble system 102 to fill in with tailored input information.

As mentioned above, the template prompt includes template description text to guide the language machine learning model. For example, the template description text could include “generate a text response referencing identified supporting digital documents.” In addition, the template description text could further include “use [digital query] and [digital documents] to generate the response.” Specifically, [digital query] and [digital documents] are the template description fields. For example, the machine learning prompt ensemble system 102 inserts the digital query 202 and supporting digital documents 210 into the brackets and provides the entire text prompt to the language machine learning model 204.

To illustrate, in some embodiments, the machine learning prompt ensemble system 102 operates as a digital assistant for a specific application. In such cases, the machine learning prompt ensemble system 102 uses a template prompt that reads:

Prompt = “ “
Perform the function of a Digital Assistant
-Digital Assistant may be provided with examples
-Some of the examples include positive examples and some of the examples
may include negative examples
-Digital Assistant must be friendly, polite, positive, creative, and intelligent
-Digital Assistant will generate a response for the last user message
Examples:
Digital query: What is a segment?
Digital Assistant: A segment is a set of accounts that meet user-defined
conditions specified by selected metrics. Segments are used to identify subsets
of visitors based on characteristics or website interactions. Segments are
defined by rules that are driven by filter criteria similar to smart lists. Segments
can be built into a dashboard report, or bookmarked for quick access.
Documents: [supporting documents]
User: [digital query]
Digital Assistant: [Response]

For instance, the above template prompt shows template description text that instructs the language machine learning model 204 to act as a “Digital Assistant” and that the “Digital Assistant” will be provided with examples of how to generate responses. Furthermore, the template description text includes positive examples (e.g., for later iterations, the template prompt could include negative examples). Additionally, the template description text instructs the language machine learning model 204 to generate the response in accordance with a certain tone and responsive to a user's query. As shown in the prompt, the template prompt further includes a positive example of a query and a response.

In addition to the template description text shown above, the template prompt further illustrates the template description field. As shown, the template prompt includes a field for supporting documents (“[supporting documents]”), thus once the machine learning prompt ensemble system 102 identifies the supporting digital documents 210, the machine learning prompt ensemble system 102 inserts the supporting digital documents 210 (e.g., the text of the supporting digital documents 210, a summary of the supporting digital documents 210, or in some instances an indicator or pointer to the supporting digital documents 210) into the field [supporting documents]. Moreover, the machine learning prompt ensemble system 102 inserts the digital query submitted by the user into [digital query].

As shown in FIG. 2A, the machine learning prompt ensemble system 102 uses the template prompt that includes the digital query 202 to generate a first text response 208. Specifically, the machine learning prompt ensemble system 102 uses the language machine learning model 204 to analyze the text prompt and generate the first text response 208. Furthermore, the machine learning prompt ensemble system 102 compares the first text response 208 with the supporting digital documents 210 using the alignment score model 206. As shown, from the comparison, the machine learning prompt ensemble system 102 extracts or identifies a misalignment portion 212 of the first text response 208.

Continuing to FIG. 2B, FIG. 2B illustrates the machine learning prompt ensemble system 102 further utilizing the misalignment portion 212 of the first text response 208 to generate an additional text response. Specifically, FIG. 2B illustrates the machine learning prompt ensemble system 102 feeding the misalignment portion 212 of the first text response 208 (and/or the digital query 202) as input to the language machine learning model 204.

As shown in FIG. 2B, the machine learning prompt ensemble system 102 generates a second text response 214 from the misalignment portion 212 of the first text response 208. For example, the machine learning prompt ensemble system 102 utilizes the language machine learning model 204 to generate the second text response 214 by analyzing the misalignment portion 212 and the digital query 202. Moreover, the machine learning prompt ensemble system 102 further compares the second text response 214 with the supporting digital documents 210. Specifically, the machine learning prompt ensemble system 102 utilizes the alignment score model 206 to compare the second text response 214 and the supporting digital documents 210 to determine alignment scores. Moreover, the machine learning prompt ensemble system 102 utilizes the alignment scores to determine and extract a misalignment portion 216 of the second text response 214.

As shown, in some embodiments, the machine learning prompt ensemble system 102 further provides the misalignment portion 216 of the second text response 214 to the language machine learning model 204 along with the digital query 202 to generate additional text response. As mentioned above, the machine learning prompt ensemble system 102 iteratively performs this process (e.g., generating text responses, identifying misalignment portions, and generating next text responses based on the misalignment portions) to reduce hallucinated content.

As mentioned above, the machine learning prompt ensemble system 102 can also select one or more responses to provide to a client device 218. For example, the machine learning prompt ensemble system 102 can compare multiple text responses with the supporting digital documents 210 (utilizing the alignment score model 206). The machine learning prompt ensemble system 102 can then provide a selected text response based on the comparison (e.g., the response with the highest alignment score). For example, in some embodiments, the machine learning prompt ensemble system 102 determines the second text response 214 has a higher alignment score than the first text response 208 and provides the second text response 214 to the client device 218.

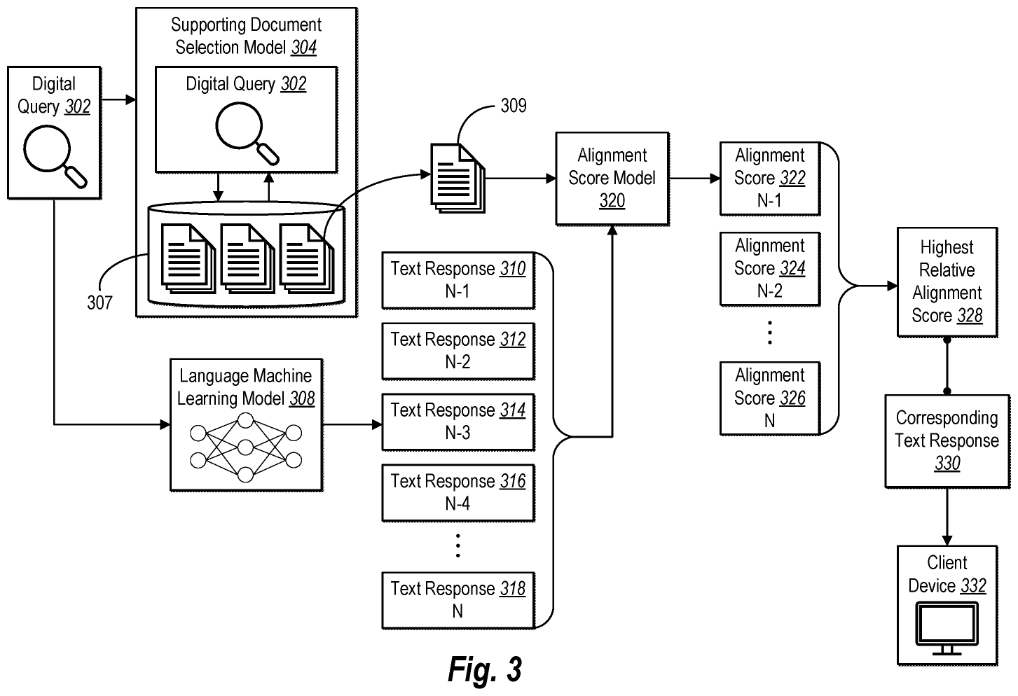

As mentioned above, in one or more implementations, the machine learning prompt ensemble system 102 iteratively generates a plurality of text responses and selects a response to reduce hallucinated content. As shown in FIG. 3, the machine learning prompt ensemble system 102 generates a plurality of text responses and further generates alignment scores for the plurality of text responses in accordance with one or more embodiments.

As shown in FIG. 3, the machine learning prompt ensemble system 102 receives a digital query 302 and from the digital query 302, the machine learning prompt ensemble system 102 identifies supporting digital documents 309. Specifically, the machine learning prompt ensemble system 102 utilizes a supporting document selection model 304 to identify the supporting digital documents 309 from a repository of digital documents 307. For example, the supporting document selection model 304 includes an embedding model.

In one or more embodiments, the “embedding model” refers to a model that processes text inputs (e.g., digital query and/or digital documents) and generates embeddings to represent words or phrases as numerical vectors in a dimensional space. Specifically, the embedding model generates embeddings that capture semantic and syntactic similarities between words. For example, the embedding model divides text into smaller units (e.g., words or sub-parts of words) and each unit is a token that includes a unique identifier. Moreover, for semantic similarity, the embedding model generates embeddings for words that are more similar (e.g., bird and chicken) closer to each other in the dimensional space. The machine learning prompt ensemble system 102 can utilize a variety of embedding models. For example, in one or more implementations, the machine learning prompt ensemble system 102 utilizes a word2vec algorithm or a CLIP embedding algorithm.

To identify the supporting digital documents 309, the machine learning prompt ensemble system 102 generates embeddings of the digital query 302 and the documents in the repository of digital documents 307 to identify the target digital documents. In one or more embodiments, the “query embedding” refers to the machine learning prompt ensemble system 102 processing the digital query 302 and generating a query embedding that represents the digital query in a multi-dimensional feature space. Further, in one or more embodiments, the “document embedding” refers to the machine learning prompt ensemble system 102 processing a digital document (from the repository of digital documents 307) and generating a document embedding that represents the document in a multi-dimensional feature space.

In some embodiments, the machine learning prompt ensemble system 102 generates the query embedding for the digital query 302 and the document embeddings for the repository of digital documents 307 and compares the embeddings in a feature space to identify digital documents within a threshold similarity (or distance within feature space) relative to the query embedding. For instance, the machine learning prompt ensemble system 102 establishes a threshold similarity and identifies all documents in the repository of digital documents 307 within the similarity as the supporting digital documents 309. In some embodiments, the machine learning prompt ensemble system 102 utilizes a clustering algorithm or other analytical model for selecting similar embeddings relative to the query embedding within a multi-dimensional feature space.

As shown in FIG. 3, the machine learning prompt ensemble system 102 utilizes a language machine learning model 308 to generate a plurality of text responses (e.g., text responses 310-318) from the digital query 302. In some embodiments, the machine learning prompt ensemble system 102 generates a text response 310 (N−1), identifies misalignment portion(s) of the text response 310 and utilizes the misalignment portion(s) and the digital query 302 to generate text response 312 (N−2). As mentioned above, the machine learning prompt ensemble system 102 performs an iterative process to sequentially reduce or eliminate hallucinated content present in a prior response. To illustrate, the text response 314 (N−3) does not contain the hallucinated content from text response 312 and 310; the text response 316 (N−4) does not contain the hallucinated content from text response 310, 312, and 314; and the text response 318 (N) does not contain the hallucinated content from text response 310, 312, 314, and 316.

As shown in FIG. 3, the machine learning prompt ensemble system 102 utilizes an alignment score model 320 to compare each of the text responses (e.g., text response 310-318) with the supporting digital documents 309. Specifically, the machine learning prompt ensemble system 102 generates an alignment score 322 (N−1) for the text response 310, an alignment score 324 (N−2) for the text response 312, and an alignment score 326 (N) for the text response 318 (e.g., each text response has a corresponding alignment score).

In one or more embodiments, the “alignment score” refers to a measure of alignment, similarity, or relevance (e.g., generated by an alignment model). An alignment score can include a measure of similarity between a query, response, and/or supporting digital documents. In some implementations, the machine learning prompt ensemble system 102 generates alignment scores on a sentence, clause, or word level (e.g., how similar a sentence of a response is to the supporting digital documents 309). In some implementations, the machine learning prompt ensemble system 102 generates alignment scores a response level (e.g., globally, how similar is the response to the supporting digital documents 309).

As shown, the machine learning prompt ensemble system 102 compares alignment scores to select a text response to surface to a client device 332. For example, the machine learning prompt ensemble system 102 identifies a highest relative alignment score 328 and a corresponding text response 330. Moreover, as shown, the machine learning prompt ensemble system 102 provides the corresponding text response 330 to the client device 332 (e.g., a client device that submitted the digital query 302).

In some embodiments, the machine learning prompt ensemble system 102 utilizes the alignment score model 320 to perform preprocessing on the text response 310 and the supporting digital documents 309. Specifically, the preprocessing includes tokenization, lowercasing, removing stop words, and reducing overall noise within the text response 310 and the supporting digital documents 309. Further, the machine learning prompt ensemble system 102 utilizes the alignment score model 320 to convert the text of the text response 310 and the supporting digital documents 309 into numerical representations (e.g., word embeddings and document embeddings), where the embeddings capture the semantic meaning of the words or phrases in a high-dimensional space.

For instance, the machine learning prompt ensemble system 102 utilizes a cosine similarity model, a Euclidean distance model or a Jaccard similarity model, to determine an alignment score between the text response 310 and the supporting digital documents 309. The alignment score model 320 is described in Y. Zha, Y. Yang, R. Li, and Z. Hu, Alignscore: Evaluating Factual Consistency with a Unified Alignment Function, arXiv preprint arXiv:2305.16739, 2023, which is fully incorporated by reference herein. Additional examples of the alignment score model 320 could include Rogue-1/L and BertScore. The Rogue-1/L score is described in C.-Y. Lin, Rouge: A package for Automatic Evaluation of Summaries, in Text Summarization Branches Out, pp. 74-81, 2004 and the BertScore is described in T. Zhang, V. Kishore, F. Wu, K. Q. Weinberger, and Y. Artzi, BertScore: Evaluating Text Generation with BERT, arXiv preprint arXiv:1904.09675, 2019.

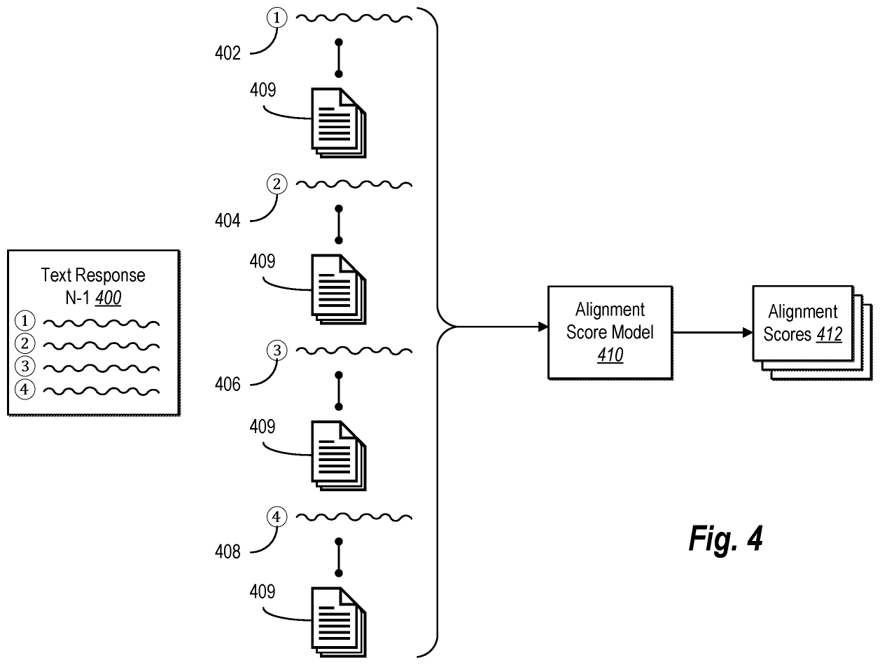

As mentioned above, in some embodiments, the machine learning prompt ensemble system 102 generates alignment scores for a response on the sentence-level. FIG. 4 illustrates the machine learning prompt ensemble system 102 comparing each sentence of a text response to supporting digital documents to generate an alignment score in accordance with one or more embodiments.

As shown in FIG. 4, the machine learning prompt ensemble system 102 utilizes a language machine learning model to generate a text response 400. Specifically, the text response 400 contains four sentences. The text response 400 includes multiple sentences, while some text response could include a single sentence.

As shown in FIG. 4, the machine learning prompt ensemble system 102 extracts each sentence of the text response 400 and utilizes an alignment score model 410 to compare each sentence with the supporting digital documents 409. As shown, the machine learning prompt ensemble system 102 utilizes a first sentence 402 paired with the supporting digital documents 409, a second sentence 404 paired with the supporting digital documents 409, a third sentence 406 paired with the supporting digital documents 409, and a fourth sentence 408 paired with the supporting digital documents 409.

For instance, as shown, the machine learning prompt ensemble system 102 utilizes the alignment score model 410 to generate alignment scores 412. For example, the machine learning prompt ensemble system 102 compares the first sentence 402 with each digital document of the supporting digital documents to identify which of the digital documents acts as a basis for the first sentence 402. Specifically, once the machine learning prompt ensemble system 102 identifies the digital documents that act as a basis for the first sentence, the machine learning prompt ensemble system 102 utilizes the alignment score model 410 to determine an alignment between the first sentence 402 and the identified digital documents.

Although FIG. 4 shows pairing the supporting digital documents with individual sentences, in some instances the machine learning prompt ensemble system 102 pairs the text response 400 (e.g., the entire response) with the supporting digital documents 409.

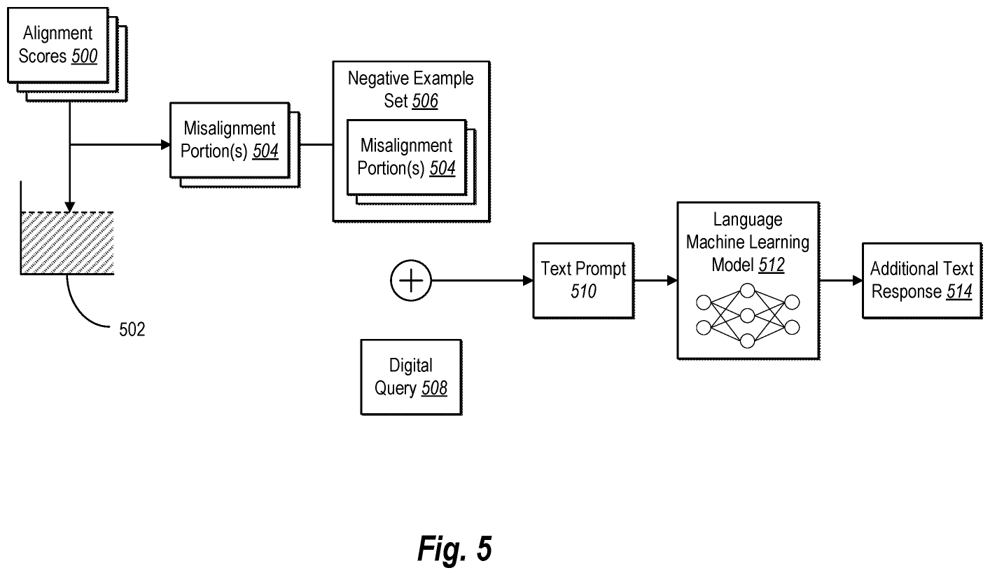

As mentioned above, in one or more implementations, the machine learning prompt ensemble system 102 utilizes an alignment threshold to generate a negative example set. FIG. 5 illustrates, the machine learning prompt ensemble system 102 comparing the alignment scores to an alignment threshold to generate a negative example set in accordance with one or more embodiments.

As mentioned above in FIGS. 3 and 4, the machine learning prompt ensemble system 102 generates the alignment scores 500 on a local level (e.g., sentence-level) or a global level (e.g., response level). As shown in FIG. 5, the machine learning prompt ensemble system 102 compares alignment scores 500 with an alignment threshold 502. In relation to FIG. 5, the machine learning prompt ensemble system 102 identifies the sentences or responses that fail to satisfy the alignment threshold 502 as misalignment portion(s) 504.

To illustrate, for a global level alignment score, the machine learning prompt ensemble system 102 generates the alignment scores 500 that includes five scores for five generated responses (0.68, 0.73, 0.52, 0.54, and 0.98). Specifically, the machine learning prompt ensemble system 102 compares each of the global level scores (0.68, 0.73, 0.52, 0.54, and 0.98) with the alignment threshold 502. For example, if the machine learning prompt ensemble system 102 preestablishes the alignment threshold 502 as 0.60, then the machine learning prompt ensemble system 102 identifies 0.52 and 0.54 as failing to satisfy the alignment threshold 502.

Moreover, the machine learning prompt ensemble system 102 determines that the responses with scores of 0.52 and 0.54 comprise the misalignment portions 504 and adds them to a negative example set 506.

In some embodiments, the machine learning prompt ensemble system 102 analyzes the responses with the scores of 0.52 and 0.54 and identifies the scores for each of the sentences of those responses. In such a circumstance, the machine learning prompt ensemble system 102 can analyze the sentences of the responses (with the initial response scores of 0.52 and 0.54) that fail to satisfy the alignment threshold 502 and adds them to the negative example set 506. Moreover, in some instances, the machine learning prompt ensemble system 102 identifies the sentence level scores of the responses (with the scores of 0.52 and 0.54) and takes the sentences with the lowest score in each response to add to the negative example set 506.

Furthermore, for a sentence level alignment score, the machine learning prompt ensemble system 102 generates the alignment scores 500 for each sentence of each response. For instance, the machine learning prompt ensemble system 102 generates scores for a first response (0.23, 0.7, 0.9), a second response (0.44, 0.67, 0.92), and a third response (0.15, 0.98, 0.99, and 0.82). Similar to the description above, in some embodiments, the machine learning prompt ensemble system 102 takes the sentence level alignment scores that fail to satisfy the alignment threshold 502 to utilize as the misalignment portion(s) 504. In some embodiments, the machine learning prompt ensemble system 102 takes the lowest alignment score for each response as the misalignment portion(s) 504 (e.g., 0.9, 0.44, and 0.15). Further, in some embodiments, the machine learning prompt ensemble system 102 identifies when a single sentence of a response fails to satisfy the alignment threshold 502 and adds the entire response to the negative example set 506.

As shown in FIG. 5, the machine learning prompt ensemble system 102 uses the negative example set 506 (e.g., that contains the misalignment portion(s) 504) and a digital query 508 to generate a text prompt 510. Specifically, the machine learning prompt ensemble system 102 first selects a text prompt template that contains a template text description, a template description field, a template negative example description, and a template negative example field.

In some embodiments, a “template negative example description” includes instructions in a text prompt to guide the language machine learning model in using the negative example set. For example, the template negative example set includes “using the negative example set, here are some possible invalid responses previously generated that are not consistent with the documents. Please avoid generating such responses if you think they are inconsistent with the documents.”

In some embodiments, the template negative example description further includes a template negative example field. Specifically, the template negative example field includes “using the negative example set, here are some possible invalid responses previously generated that are not consistent with the documents. Please avoid generating such responses if you think they are inconsistent with the documents. Please refer to [neg_i] as the negative example set.” For example, [neg_i] is the template negative example field and the machine learning prompt ensemble system 102 fills in the bracket with the sentences and/or text responses that constitute the negative examples.

To illustrate, in some embodiments, the machine learning prompt ensemble system 102 indexes each text response as 1, . . . , i−1, and takes the lowest alignment score on a sentence-level (for each response) and adds the corresponding sentence to the negative example set 506 (Neg_i). Moreover, the machine learning prompt ensemble system 102 represents a generated response as Rᵢ that corresponds with prompt i containing D sentences [sᵢ¹, . . . , sᵢ^{D}]. For instance, the machine learning prompt ensemble system 102 represents the relationship of identifying the lowest alignment score as:

sᵢ*=argmin_{s∈{s}_{ᵢ}_{¹}_{, . . . , s}_{ᵢ}_{^{D}}_{}}alignScore(s, documents)

In the above equation, sᵢ* indicates a sentence most likely to hallucinate and documents denote the supporting digital documents. Furthermore, the machine learning prompt ensemble system 102 further defines Neg_i as a concatenation of sᵢ* from each Rᵢ. In other words, the negative example set 506 is represented as:

Negᵢ=[sᵢ*, . . . , s_{N}*]

As shown in FIG. 5, the machine learning prompt ensemble system 102 utilizes a language machine learning model 512 to generate an additional text response 514 from the text prompt 510. As mentioned above, the machine learning prompt ensemble system 102 iteratively performs this process to generate a plurality of text responses to reduce the hallucinated content.

In such instances where the machine learning prompt ensemble system 102 generates a plurality of text responses, the machine learning prompt ensemble system 102 further selects a response that has the least amount of hallucinated content or the highest quality. For instance, the machine learning prompt ensemble system 102 selects a response from {R₁, . . . , R_{N}}. For example, the machine learning prompt ensemble system 102 reutilizes the alignment score model to score each of the responses {R₁, . . . , R_{N}}. To illustrate, the machine learning prompt ensemble system 102 selects a response which is represented as:

R_{*}=argmax_{r∈{R}_{₁}_{, . . . ,R}_{_{N}}_{}}alignScore(r, documents)

In the above equation, R_{*} represents the highest quality response determined from all the responses and the alignment score between each of the responses and the supporting digital documents.

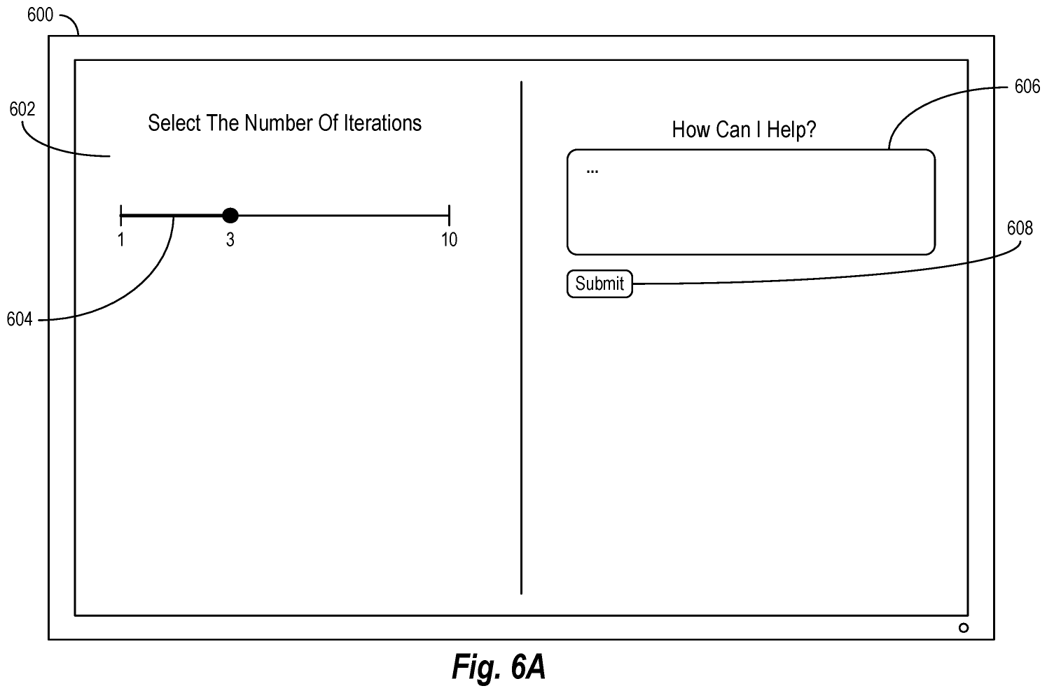

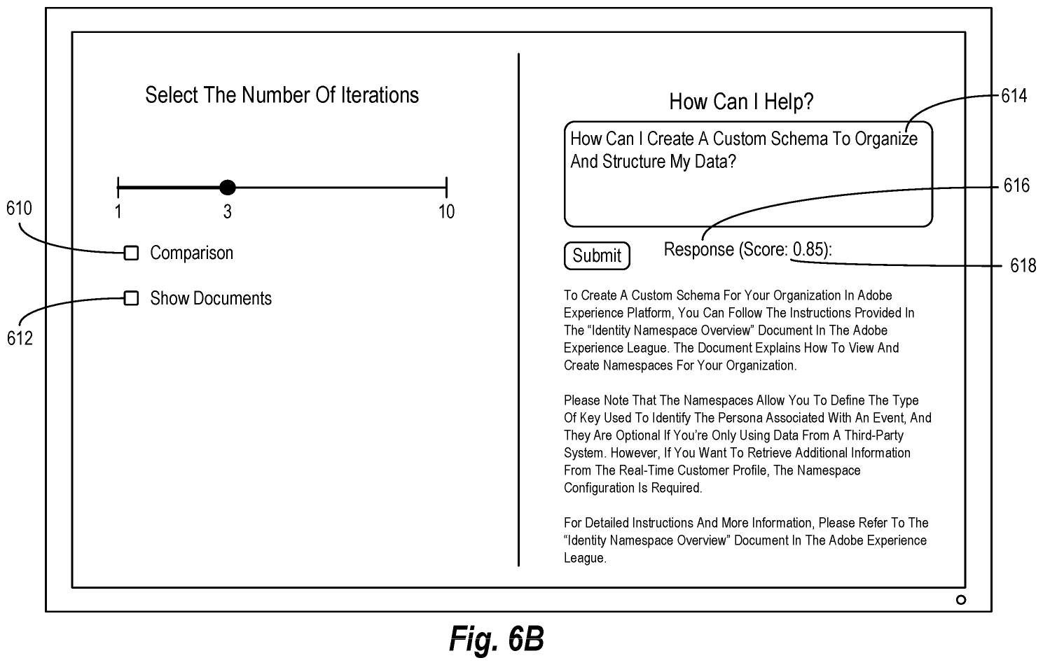

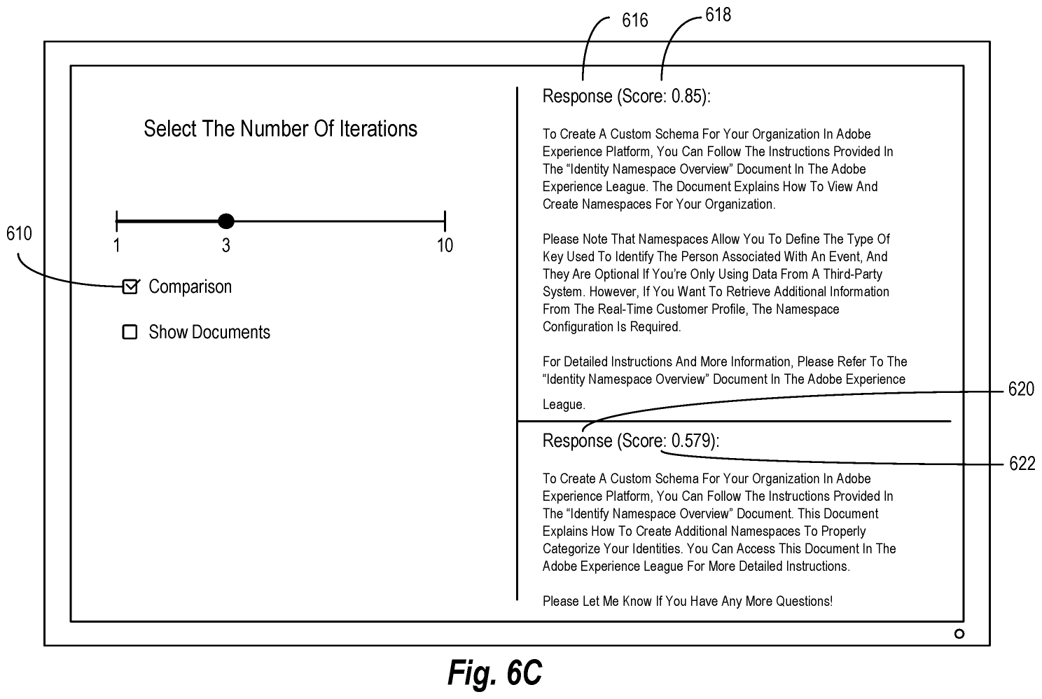

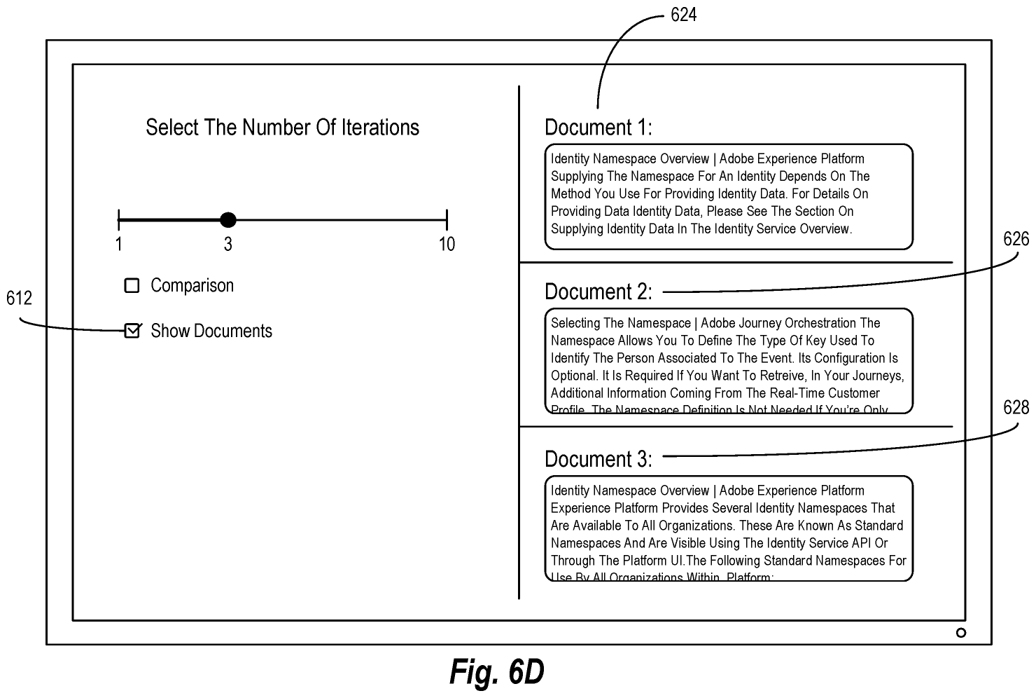

As mentioned above, in one or more implementations, the machine learning prompt ensemble system 102 provides a streamlined graphical user interface for submitting queries and receiving responses to queries. FIGS. 6A-6D shows example graphical user interfaces of a client device submitting a digital query and the machine learning prompt ensemble system 102 providing, for display, response(s) along with additional elements in accordance with one or more embodiments.

As shown in FIG. 6A, the machine learning prompt ensemble system 102 causes a graphical user interface 602 of a client device 600 to display an iteration element 604. Specifically, the iteration element 604 allows the client device 600 to indicate a number of response to iteratively generate in response to a digital query. As described above, the machine learning prompt ensemble system 102 takes a response, extracts a misalignment portion of the response, and generates another text prompt with the digital query and the misalignment portion. In other words, the iteration element 604 indicates to the machine learning prompt ensemble system 102 the number of times to repeat the iterative process described above (e.g., the number of responses to generate based on iteratively adding misalignment portions to a negative example set in a text prompt from previous text responses). Furthermore, FIG. 6A shows that the graphical user interface 602 displays a digital query input 606 to input a digital query and a submit element 608 to submit the digital query.

FIG. 6B illustrates a submission of a query and the machine learning prompt ensemble system 102 showing a response in accordance with one or more embodiments. FIG. 6B shows a digital query 614 that reads “how can I create a custom schema to organize and structure my data?” Specifically, FIG. 6B also shows that from submitting the digital query 614, the machine learning prompt ensemble system 102 generates a response 616 with an alignment score 618 (0.85). For example, the machine learning prompt ensemble system 102 receives the submission of the digital query 614, identifies supporting digital documents for the digital query 614, and selects a text prompt template to populate with the digital query 614. Moreover, the machine learning prompt ensemble system 102 analyzes the resulting text prompt utilizing a language machine learning model to generate the response.

For example, FIG. 6B shows the machine learning prompt ensemble system 102 generating a response of “to create a custom schema for your organization in Adobe Experience Platform, you can follow the instructions provided in the ‘identity namespace overview’ document in the Adobe Experience League. The document explains how to view and create namespaces for your organization. Please note that the namespace allows you to define the type of key used to identify the persona associated with an event, and they are optional if you're only using data from a third-party system. However, if you want to retrieve additional information from the real-time customer profile, the namespace configuration is required. For detailed instructions and more information, please refer to the ‘identity namespace overview’ document in the Adobe Experience League.” Moreover, the machine learning prompt ensemble system 102 displays an alignment score 618 of 0.85, which indicates a measure of alignment (e.g., 85% alignment) of the response with the supporting digital documents.

Furthermore, FIG. 6B shows the machine learning prompt ensemble system 102 causing the graphical user interface to display a comparison element 610 and a supporting digital documents element 612. Specifically, selecting the comparison element 610 results in the machine learning prompt ensemble system 102 causing the graphical user interface to display the generated responses compared to one another. Moreover, selecting the supporting digital documents element 612 results in the machine learning prompt ensemble system 102 showing the supporting digital documents used to generate the response 616.

As shown in FIG. 6C, the machine learning prompt ensemble system 102 receives a selection of the comparison element 610 and causes the graphical user interface to display the response 616 and a response 620. As shown, the response 616 varies from the response 620 and the response 620 further has an alignment score 622 of 0.579. In some embodiments, the machine learning prompt ensemble system 102 causes the graphical user interface to display the response from highest alignment score to lowest alignment score. For instance, as discussed above, the machine learning prompt ensemble system 102 iteratively generates response with each subsequent response eliminating hallucinated content form the prior response. Thus, selecting the comparison element 610 results in the machine learning prompt ensemble system 102 causing the graphical user interface to show each of the iteratively generated responses (e.g., the number of responses corresponding to the iteration element 604).

As shown in FIG. 6D, the machine learning prompt ensemble system 102 receives a selection of the supporting digital documents element 612. The selection causes the graphical user interface to display a first supporting digital document 624, a second supporting digital document 626, and a third supporting digital document 628. For example, the machine learning prompt ensemble system 102 causes the graphical user interface to display a plurality of supporting digital documents and allows a client device to scroll through the interface to view additional supporting digital documents not initially shown within the graphical user interface. In one or more embodiments, the machine learning prompt ensemble system 102 causes the graphical user interface to emphasize specific portions of the response 616 and/or the response 620. For instance, the machine learning prompt ensemble system 102 causes the graphical user interface to highlight, underline, or bold a part of the response 616 and/or the response 620 that corresponds to portions of the responses that result in a lower alignment score (e.g., a specific sentence within the response 620 is highlighted as a result of that sentence not being grounded by the supporting digital documents).

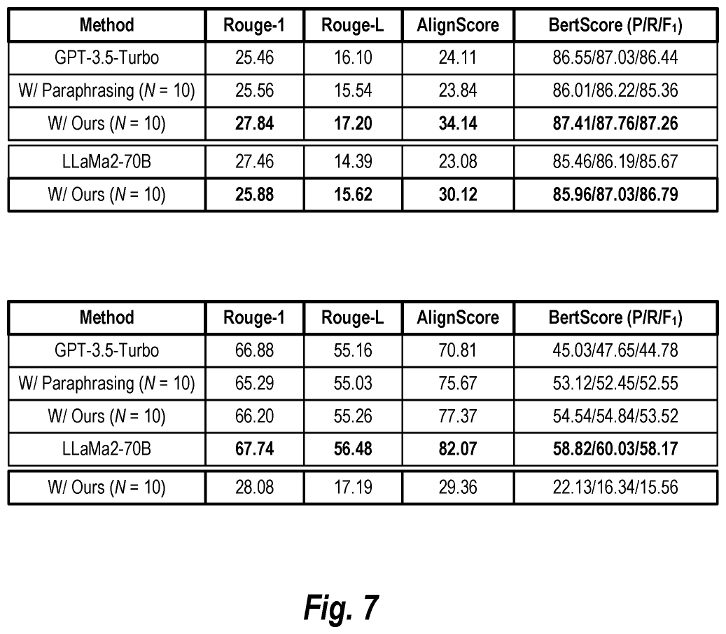

FIG. 7 illustrates tables comparing generative text response from the machine learning prompt ensemble system 102 and prior systems in accordance with one or more embodiments. Specifically, experimenters utilized an ELI5 dataset of long form question and answers as described in A. Fan, Y. Jenite, E. Perez, D. Grangier, J. Weston, and M. Auli, Eli5: Long Form Question Answering, arXiv preprint arXiv:1907.09190, 2019. For example, experimenters use both GPT-3.5 turbo and LLaMa2 for answer/response generation. GPT-3.5 turbo is described in A. Koubaa, GPT-4 vs. GPT-3.5: A Concise Showdown, 2023. LlaMa2 is described in H. Touvrou, L. Martin, K. Stone, P. Albert, A. Almahairi, Y. Babaei, N. Bashlykov, S. Batra, P. Bhargava, S. Bhosale, et al., Llama 2: Open Foundation and Fine-Tuned Chat Models, arXiv preprint arXiv:2307.09288, 2023.

As shown in FIG. 7, the experimenters use the following metrics, Rogue-1/L (e.g., evaluates whether the generated candidate response is consistent with the provided ground truth response), AlignScore (e.g., a score for hallucination computed from a pre-trained classifier that predicts how well a candidate response is grounded by the supporting documents in the prompt), and a BertScore (e.g., a score that capture hallucination errors).

As shown in FIG. 7, the top table shows a method (e.g., GPT-3.5, LLaMa2, or the machine learning prompt ensemble system 102) and a corresponding score for each of the models without ensemble (e.g., iterative generation of prompts). As illustrated, the experimental implementation of the machine learning prompt ensemble system 102 (e.g., w/Ours) generally demonstrates a superior score compared to prior methods. Further, the bottom table (e.g., which involves ensemble) demonstrates that the example implementation of the machine learning prompt ensemble system 102 is more accurate in resolving questions/queries (as indicated by a higher Rogue score) but also more faithful to the supporting documents by inducing less hallucination errors (e.g., higher AlignScores and BertScores).

Turning to FIG. 8, additional detail will now be provided regarding various components and capabilities of the machine learning prompt ensemble system 102. In particular, FIG. 8 illustrates an example schematic diagram of a computing device 800 (e.g., the server(s) 104 and/or the client device 116) implementing the machine learning prompt ensemble system 102 in accordance with one or more embodiments of the present disclosure for components 800-810. As illustrated in FIG. 8, the machine learning prompt ensemble system 102 includes a digital document selection manager 802, a language machine learning manager 806, an alignment score model manager 808, an additional response manager 810, and a storage manager 812.

The digital document selection manager 802 selects one or more supporting digital documents. For example, the digital document selection manager 802 receives via user input from a client device, a digital query. In particular, the digital document selection manager 802 identifies target documents from the digital query and further identifies the relevant supporting digital documents. For instance, the digital document selection manager 802 utilizes a supporting document selection model to generate embeddings for the digital query and embeddings for the digital documents and further compares the embeddings to identify the relevant digital documents.

The language machine learning manager 806 generates responses to digital queries. For example, the language machine learning manager 806 trains the language machine learning model either locally or remotely on a third-party server. Furthermore, the language machine learning manager 806 passes values such as a text prompt that includes the digital query to a language machine learning model. Thus, the language machine learning manager 806 generates text responses directly responsive to a digital query.

The alignment score model manager 808 extracts misalignment portions. For example, the alignment score model manager 808 receives text responses generated by the language machine learning model and uses an alignment score model to determine misalignment portions of the text response. In particular, the alignment score model manager 808 compares the text response to the supporting digital documents to determine the misalignment portions. Based on the determination, the alignment score model manager 808 further extracts the misalignment portions to utilize in a negative example set. Further, in some instances, the alignment score model manager 808 also selects the highest quality (e.g., least likely to hallucinate) response from a plurality of responses.

The additional response manager 810 performs an iterative process of generating multiple text responses. For example, the additional response manager 810 receives the digital query and the misalignment portion (e.g., a negative example set) and generates additional text responses. In particular, the additional response manager 810 sequentially generates prompts with an updated negative example set (e.g., that includes misalignment portions from the prior response) to generate additional responses without the hallucinated content form the prior response. The additional response manager 810 can also compare responses (e.g., utilizing an alignment model) and provide responses for display.

The storage manager 812 stores a plurality of content from the machine learning prompt ensemble system 102 and corresponding client devices. In one or more embodiments, the storage manager 812 is implemented as part of a storage medium/device. For example, the storage manager 812 stores digital text prompts, digital text queries, supporting digital documents, and text responses. In particular, the storage manager 812 includes a repository of digital documents to store the supporting digital documents. Thus, in some embodiments, the other components of the machine learning prompt ensemble system 102 interacts with the storage manager 812 to gain access to the repository of digital documents. Furthermore, in some embodiments, the storage manager stores client device history and other activity performed by a client device that accesses an environment operating with the machine learning prompt ensemble system 102.

Each of the components 802-812 of machine learning prompt ensemble system 102 can include software, hardware, or both. For example, the components 802-812 can include one or more instructions stored on a computer-readable storage medium and executable by processors of one or more computing devices, such as a client device or server device. When executed by the one or more processors, the computer-executable instructions of the machine learning prompt ensemble system 102 can cause the computing device(s) to perform the methods described herein. Alternatively, the components 802-812 can include hardware, such as a special-purpose processing device to perform a certain function or group of functions. Alternatively, the components 802-812 of the machine learning prompt ensemble system 102 can include a combination of computer-executable instructions and hardware.

Furthermore, the components 802-812 of the machine learning prompt ensemble system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 802-812 of the machine learning prompt ensemble system 102 may be implemented as a stand-alone application, such as a desktop or mobile application. Furthermore, the components 802-812 of the machine learning prompt ensemble system 102 may be implemented as one or more web-based applications hosted on a remote server. Alternatively, or additionally, the components 802-812 of the machine learning prompt ensemble system 102 may be implemented in a suite of mobile device applications or “apps.” For example, in one or more embodiments, the machine learning prompt ensemble system 102 can comprise or operate in connection with digital software applications such as ADOBE® ANALYTICS and ADOBE® EXPERIENCE PLATFORM. The foregoing are either registered trademarks or trademarks of Adobe Inc. in the United States and/or other countries.

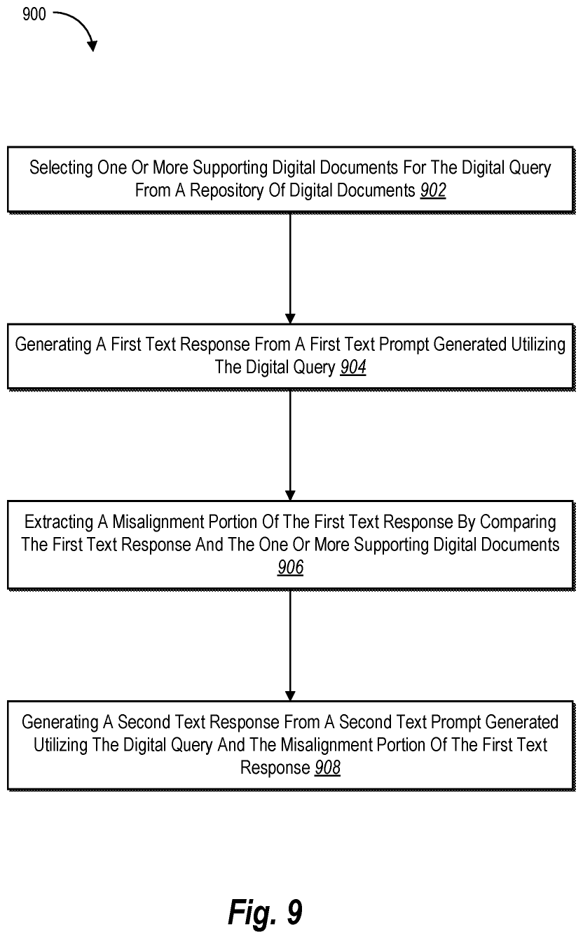

FIGS. 1-8, the corresponding text, and the examples provide a number of different methods, systems, devices, and non-transitory computer-readable media of the machine learning prompt ensemble system 102. In addition to the foregoing, one or more embodiments can also be described in terms of flowcharts comprising acts for accomplishing the particular result, as shown in FIG. 9. FIG. 9 may be performed with more or fewer acts. Further, the acts may be performed in different orders. Additionally, the acts described herein may be repeated or performed in parallel with one another or in parallel with different instances of the same or similar acts.

FIG. 9 illustrates a flowchart of a series of acts 900 for generating an additional text response utilizing a machine learning model in accordance with one or more embodiments. FIG. 9 illustrates acts according to one embodiment, alternative embodiments may omit, add to, reorder, and/or modify any of the acts shown in FIG. 9. In some implementations, the acts of FIG. 9 are performed as part of a method. For example, in some embodiments, the acts of FIG. 9 are performed as part of a computer-implemented method. Alternatively, a non-transitory computer-readable medium can store instructions thereon that, when executed by at least one processor, cause a computing device to perform the acts of FIG. 9. In some embodiments, a system performs the acts of FIG. 9. For example, in one or more embodiments, a system includes at least one memory device. The system further includes at least one server device configured to cause the system to perform the acts of FIG. 9.

The series of acts 900 includes an act 902 of selecting one or more supporting digital documents for the digital query from a repository of digital documents. Further, the series of acts 900 includes an act 904 of generating a first text response from a first text prompt generated utilizing the digital query. For example, the series of acts 900 includes an act 906 of extracting a misalignment portion of the first text response by comparing the first text response and the one or more supporting digital documents. Further, the series of acts 900 includes an act 908 of generating a second text response from a second text prompt generated utilizing the digital query and the misalignment portion of the first text response.

In particular, the act 902 includes in response to receiving a digital query from a client device, selecting one or more supporting digital documents for the digital query from a repository of digital documents. Further, the act 904 includes generating, utilizing a language machine learning model, a first text response from a first text prompt generated utilizing the digital query. Moreover, the act 906 includes extracting, utilizing an alignment score model, a misalignment portion of the first text response by comparing the first text response and the one or more supporting digital documents. Furthermore, the act 908 includes generating, utilizing the language machine learning model, a second text response from a second text prompt generated utilizing the digital query and the misalignment portion of the first text response.

For example, in one or more embodiments, the series of acts 900 includes generating, utilizing an embedding model, query embeddings from the digital query and document embeddings from the repository of digital documents. In addition, in one or more embodiments, the series of acts 900 includes comparing the query embeddings with the document embeddings to identify the one or more supporting digital documents. Further, in one or more embodiments, the series of acts 900 includes comparing, utilizing the alignment score model, sentences of the first text response with the one or more supporting digital documents to generate alignment scores that indicate measures of alignment between the sentences of the first text response with the one or more supporting digital documents.

Moreover, in one or more embodiments, the series of acts 900 includes comparing the alignment scores to an alignment threshold. Further, in one or more embodiments, the series of acts 900 includes extracting the misalignment portion of the first text response based on determining that an alignment score of the alignment scores fails to satisfy the alignment threshold. Moreover, in one or more embodiments, the series of acts 900 includes generating a negative example set by adding the misalignment portion of the first text response to the negative example set. Further, in one or more embodiments, the series of acts 900 includes generating the second text prompt to include the negative example set. Moreover, in one or more embodiments, the series of acts 900 includes extracting, utilizing the alignment score model, an additional misalignment portion of the second text response by comparing the second text response and the one or more supporting digital documents. Further, in one or more embodiments, the series of acts 900 includes adding the additional misalignment portion of the second text response to the negative example set.

Additionally, in one or more embodiments, the series of acts 900 includes generating, utilizing the alignment score model, a first alignment score for the first text response by comparing the first text response with the one or more supporting digital documents. Moreover, in one or more embodiments, the series of acts 900 includes generating, utilizing the alignment score model, a second alignment score for a second text response by comparing the second text response with the one or more supporting digital documents. Further, in one or more embodiments, the series of acts 900 includes selecting either the first text response or the second text response to provide to the client device based on the first alignment score and the second alignment score.

Furthermore, in one or more embodiments, the series of acts 900 includes generating, utilizing the language machine learning model, a first text response from the digital text query. Moreover, in one or more embodiments, the series of acts 900 includes extracting, utilizing an alignment score model, a first misalignment portion of the first text response by comparing the first text response and the one or more supporting digital documents. Moreover, in one or more embodiments, the series of acts 900 includes generating a text prompt utilizing the first misalignment portion of the first text response and the digital text query. Furthermore, in one or more embodiments, the series of acts 900 includes generating, utilizing the language machine learning model, a second text response to the digital text query from the text prompt.

Moreover, in one or more embodiments, the series of acts 900 includes comparing, utilizing the alignment score model, sentences of the first text response with the one or more supporting digital documents to generate alignment scores that indicate measures of alignment between the sentences of the first text response and the one or more supporting digital documents. Further, in one or more embodiments, the series of acts 900 includes comparing the alignment scores to an alignment threshold to extract the first misalignment portion of the first text response. Moreover, in one or more embodiments, the series of acts 900 includes generating the text prompt by generating a negative example set that comprises the first misalignment portion of the first text response. Further, in one or more embodiments, the series of acts 900 includes extract a second misalignment portion of the second text response to add to the negative example set. Moreover, in one or more embodiments, the series of acts 900 includes generating an additional text prompt comprising the negative example set and the digital text query from the client device.

Further, in one or more embodiments, the series of acts 900 includes generating, utilizing the language machine learning model, a third text response to the digital text query from the additional text prompt. Moreover, in one or more embodiments, the series of acts 900 includes generating a plurality of alignment scores comprising a first alignment score for the first text response, a second alignment score for the second text response, and a third alignment score for the third text response. Further, in one or more embodiments, the series of acts 900 includes selecting a text response comprising at least one of the first text response, the second text response or the third text response based on the plurality of alignment scores to provide to the client device.

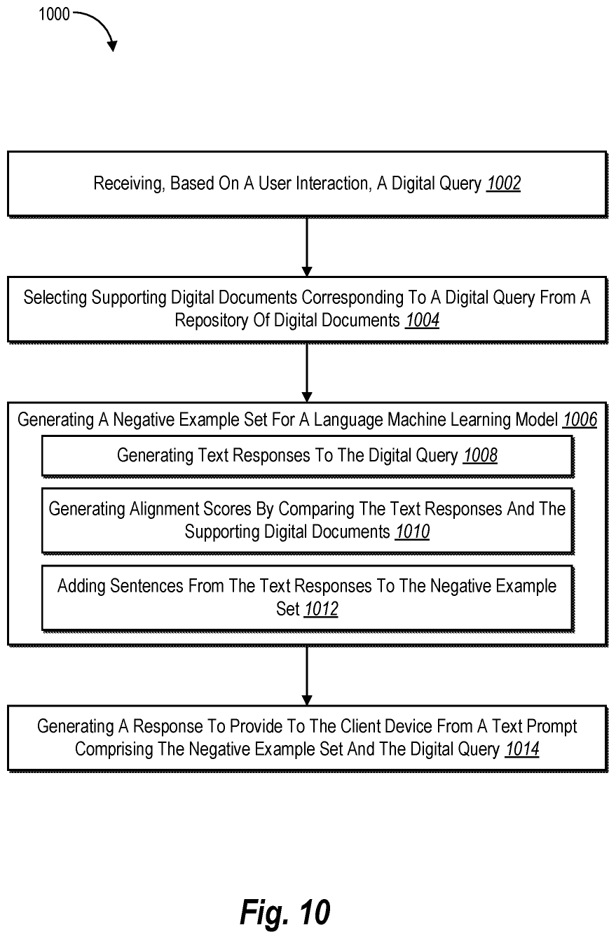

FIG. 10 illustrates a flowchart of a series of acts 1000 for generating a negative example set in accordance with one or more embodiments. FIG. 10 illustrates acts according to one embodiment, alternative embodiments may omit, add to, reorder, and/or modify any of the acts shown in FIG. 10. In some implementations, the acts of FIG. 10 are performed as part of a method. For example, in some embodiments, the acts of FIG. 10 are performed as part of a computer-implemented method. Alternatively, a non-transitory computer-readable medium can store instructions thereon that, when executed by at least one processor, cause a computing device to perform the acts of FIG. 10. In some embodiments, a system performs the acts of FIG. 10. For example, in one or more embodiments, a system includes at least one memory device. The system further includes at least one server device configured to cause the system to perform the acts of FIG. 10.

The series of acts 1000 includes an act 1002 of receiving, based on a user interaction, a digital query. Moreover, the series of acts 1000 includes an act 1004 of selecting supporting digital documents corresponding to a digital query from a repository of digital documents. Further, the series of acts 1000 includes an act 1006 of generating a negative example set for a language machine learning model. Moreover, the act 1006 includes a sub-act 1008 of generating text responses to the digital query, a sub-act 1010 of generating alignment scores by comparing the text responses and the supporting digital documents, and a sub-act 1012 of adding sentences from the text responses to the negative example set. Additionally, the series of acts 1000 includes an act 1014 of generating a response to provide to the client device from a text prompt comprising the negative example set and the digital query.

In particular, the act 1002 includes receiving, based on user interaction with a user interface of a client device, a digital query. Further, the act 1004 includes selecting, utilizing a supporting document selection model, supporting digital documents corresponding to a digital query from a repository of digital documents. Moreover, the act 1006 includes generating a negative example set for a language machine learning model by the sub-act 1008 which includes generating, utilizing the language machine learning model, text responses to the digital query, the sub-act 1010 of generating alignment scores by comparing, utilizing an alignment score model, the text responses and the supporting digital documents, and the sub-act 1012 of adding sentences from the text responses to the negative example set based on the alignment scores. Moreover, the act 1014 includes generating, utilizing a language machine learning model, a response to provide to the client device from a text prompt comprising the negative example set and the digital query.

Further, in one or more embodiments, the series of acts 1000 includes comparing sentences of the text responses with the supporting digital documents to generate alignment scores that indicate measures of alignment between the sentences of the text responses and the supporting digital documents. Moreover, in one or more embodiments, the series of acts 1000 includes comparing the alignment scores to an alignment threshold to determine that an alignment score fails to satisfy the alignment threshold. Further, in one or more embodiments, the series of acts 1000 includes adding one or more sentences of the text responses that fail to satisfy the alignment threshold to the negative example set.

Further, in one or more embodiments, the series of acts 1000 includes receiving, via the user interface of the client device, a number of iterations, the number of iterations indicating a number of text responses to generate. Moreover, in one or more embodiments, the series of acts 1000 includes providing the response to the client device for display based on an alignment score of the response being higher than other alignment scores. Further, in one or more embodiments, the series of acts 1000 includes providing the response to the client device and further providing, to the client device for display, at least a portion of one or more of the supporting digital documents.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., the server(s) 104 and/or the client device 116). In one or more embodiments, the computing device 1100 may be a mobile device (e.g., a mobile telephone, a smartphone, a PDA, a tablet, a laptop, a camera, a tracker, a watch, a wearable device). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
in response to receiving a digital query from a client device, generating a plurality of text responses to the digital query and selecting a text response from the plurality of text responses to transmit to the client device by:
selecting one or more supporting digital documents for the digital query from a repository of digital documents;
generating, utilizing a language machine learning model, a first text response to the digital query from a first text prompt generated utilizing the digital query;
extracting, utilizing an alignment score model, a misalignment portion of the first text response by comparing the first text response and the one or more supporting digital documents, wherein the misalignment portion indicates content in the first text response that is hallucinated by the language machine learning model;
generating a negative example set comprising the misalignment portion of the first text response;
generating a second text prompt from the digital query and the negative example set;
generating, utilizing the language machine learning model, a second text response to the digital query from the second text prompt generated utilizing the digital query and the negative example set; and
based on comparing a first alignment score for the first text response and a second alignment score for the second text response, selecting the second text response to transmit to the client device instead of the first text response.

2. The computer-implemented method of claim 1, wherein selecting the one or more supporting digital documents comprises:
generating, utilizing an embedding model, query embeddings from the digital query and document embeddings from the repository of digital documents; and
comparing the query embeddings with the document embeddings to identify the one or more supporting digital documents.

3. The computer-implemented method of claim 1, wherein extracting the misalignment portion of the first text response utilizing the alignment score model comprises: comparing, utilizing the alignment score model, sentences of the first text response with the one or more supporting digital documents to generate alignment scores that indicate measures of alignment between the sentences of the first text response with the one or more supporting digital documents.

4. The computer-implemented method of claim 3, wherein extracting the misalignment portion for the first text response comprises:
comparing the alignment scores to an alignment threshold; and
extracting the misalignment portion of the first text response based on determining that an alignment score of the alignment scores fails to satisfy the alignment threshold.

5. The computer-implemented method of claim 1, wherein selecting the second text response further comprises:
generating a third text prompt from the digital query and the negative example set comprising the misalignment portion of the first text response and a misalignment portion of the second text response;
generating, utilizing the language machine learning model, a third text response from the third text prompt; and
based on comparing the first alignment score for the first text response, the second alignment score for the second text response, and a third alignment score for the third text response, selecting the second text response to transmit to the client device instead of the first text response or the third text response.

6. The computer-implemented method of claim 1, wherein generating the negative example set further comprises:
comparing each sentence of the first text response to the one or more supporting digital documents to generate a plurality of alignment scores; and
selecting a sentence from the first text response to add to the negative example set by comparing the plurality of alignment scores.

7. The computer-implemented method of claim 1, further comprising generating, utilizing the alignment score model, the first alignment score for the first text response by comparing the first text response with the one or more supporting digital documents.

8. The computer-implemented method of claim 7, further comprising:
generating, utilizing the alignment score model, the second alignment score for the second text response by comparing the second text response with the one or more supporting digital documents; and
transmitting the second alignment score and the second text response to the client device.

9. A system comprising:
one or more memory devices comprising a language machine learning model, a digital text query from a client device, and one or more supporting digital documents corresponding to the digital text query; and
one or more processors configured to cause the system to generate a plurality of text responses to the digital text query and select a text response from the plurality of text responses to transmit to the client device by:
generating, utilizing the language machine learning model, a first text response to the digital text query from a first text prompt generated utilizing the digital text query;
extracting, utilizing an alignment score model, a first misalignment portion of the first text response by comparing the first text response and the one or more supporting digital documents, wherein the first misalignment portion indicates content in the first text response that is hallucinated by the language machine learning model;
generating a negative example set comprising the first misalignment portion of the first text response;
generating a second text prompt from the digital text query and the negative example set;
generating, utilizing the language machine learning model, a second text response to the digital text query from the second text prompt; and
based on comparing a first alignment score for the first text response and a second alignment score for the second text response, selecting the second text response to transmit to the client device instead of the first text response.

10. The system of claim 9, wherein the one or more processors are configured to cause the system to extract the first misalignment portion by:
comparing, utilizing the alignment score model, sentences of the first text response with the one or more supporting digital documents to generate alignment scores that indicate measures of alignment between the sentences of the first text response and the one or more supporting digital documents; and
comparing the alignment scores to an alignment threshold to extract the first misalignment portion of the first text response.

11. The system of claim 9, further comprising identifying the one or more supporting digital documents by:
generating, utilizing an embedding model, query embeddings that represent the digital text query;
generating, utilizing the embedding model, document embeddings that represents digital documents in a repository of digital documents; and
identifying the one or more supporting digital documents based on comparing the query embeddings and the document embeddings.

12. The system of claim 944, wherein the one or more processors are configured to cause the system to:
extract a second misalignment portion of the second text response to add to the negative example set; and
generate an additional text prompt comprising the negative example set and the digital text query from the client device.

13. The system of claim 12, wherein the one or more processors are configured to cause the system to generate, utilizing the language machine learning model, a third text response to the digital text query from the additional text prompt.

14. The system of claim 13, wherein the one or more processors are configured to cause the system to:
generate a plurality of alignment scores comprising the first alignment score for the first text response, the second alignment score for the second text response, and a third alignment score for the third text response; and
transmit the second alignment score to the client device along with the second text response.

15. A non-transitory computer-readable medium storing executable instructions which, when executed by at least one processing device, cause the at least one processing device to perform operations comprising:
receiving, based on user interaction with a user interface of a client device, a digital query; and
generating a plurality of text responses to the digital query and selecting a text response from the plurality of text responses to transmit to the client device by:
selecting, utilizing a supporting document selection model, supporting digital documents corresponding to the digital query from a repository of digital documents;
generating a negative example set for a language machine learning model by:
generating, utilizing the language machine learning model, the plurality of text responses to the digital query;
generating a plurality of alignment scores for the plurality of text responses to the digital query by comparing, utilizing an alignment score model, the plurality of text responses and the supporting digital documents, wherein the plurality of alignment scores indicate content in the plurality of text responses that are hallucinated by the language machine learning model; and
adding sentences from the plurality of text responses to the negative example set based on the plurality of alignment scores; and
based on comparing the plurality of alignment scores, selecting a second text response to transmit to the client device instead of a first text response.

16. The non-transitory computer-readable medium of claim 15, wherein generating alignment scores comprises comparing sentences of the plurality of text responses with the supporting digital documents to generate alignment scores that indicate measures of alignment between the sentences of the plurality of text responses and the supporting digital documents.

17. The non-transitory computer-readable medium of claim 15, wherein adding sentences from the plurality of text responses to the negative example set comprises:
comparing the plurality of alignment scores to an alignment threshold to determine that an alignment score fails to satisfy the alignment threshold; and
adding one or more sentences of the plurality of text responses that fail to satisfy the alignment threshold to the negative example set.

18. The non-transitory computer-readable medium of claim 15, wherein generating the plurality of text responses to the digital query further comprises receiving, via the user interface of the client device, a number of iterations, the number of iterations indicating a number of text responses to generate.

19. The non-transitory computer-readable medium of claim 15, further comprising providing a second alignment score along with the second text response to the client device for display.

20. The non-transitory computer-readable medium of claim 15, further comprising providing the second text response to the client device and further providing, to the client device for display, at least a portion of one or more of the supporting digital documents.
